(19) United States
(12) Patent Application Publication
(10) Pub. No.: US 2007/0253066 A1
(43) Pub. Date: Nov. 1, 2007

(54) Hard-coated antiglare film, polarizing plate, image display, and method of manufacturing hard-coated antiglare film

(75) Inventors: Hiroyuki Takao, Ibaraki-shi (JP); Daisuke Hamamoto, Ibaraki-shi (JP); Masaki Ninomiya, Ibaraki-shi (JP); Seiichi Kusumoto, Ibaraki-shi (JP); Takayuki Shigematsu, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/790,289

(22) Filed: Apr. 24, 2007

(30) Foreign Application Priority Data
Apr. 26, 2006 (JP) 2006-122709
Sep. 4, 2006 (JP) 2006-239139

(51) Int. Cl. G02B 27/00

(52) U.S. Cl. 359/601

(57) ABSTRACT

A hard-coated antiglare film is provided that has high hardness and excellent antiglare properties and can prevent white blur from occurring when viewed from oblique directions. The hard-coated antiglare film of the present invention includes a transparent plastic film substrate and a hard-coating antiglare layer that is formed of fine particles and a hard-coating resin on at least one surface of the transparent plastic film substrate. The hard-coating antiglare layer has a thickness of 15 to 30 μm, the fine particles have a weight average particle size of 30 to 75% of a thickness of the hard-coating antiglare layer, in the unevenness of the hard-coating antiglare layer surface that is formed by the fine particles, an average tilt angle θa is 1.0° to 2.0°, and an arithmetic average surface roughness Ra according to JIS B 0601 (1994 version) is 0.12 to 0.30 μm.

### FIELD OF THE INVENTION

The present invention relates generally to a hard-coated antiglare film, a polarizing plate, an image display, and a method of manufacturing hard-coated antiglare film.

### BACKGROUND OF THE INVENTION

With technical improvement in recent years, liquid crystal displays (LCDs), plasma display panels (PDPs), electroluminescence displays (ELDs), etc. have been developed in addition to conventional cathode ray tubes (CRTs) as image displays and have been used practically. As LCDs have been technically improved to provide wide viewing angles, high resolution, high response, good color reproduction, and the like, applications of LCDs are spreading from laptop personal computers and monitors to television sets. In a basic LCD structure, a pair of flat glass substrates each provided with a transparent electrode are opposed via a spacer to form a constant gap, between which a liquid crystal material is placed and sealed to form a liquid crystal cell, and a polarizing plate is formed on the outside surface of each of the pair of glass substrates. In a conventional technique, a glass or plastic cover plate is attached to the surface of the liquid crystal cell in order to prevent scratches on the polarizing plate bonded to the surface of the liquid crystal cell. However, the placement of such a cover plate is disadvantageous in terms of cost and weight. Thus, a hard coating process has gradually been used to treat the surface of polarizing plates. It is common in the hard-coating process that a hard-coated antiglare film is used so as to serve also to prevent, for example, glare of LCDs and reflection of a light source onto LCDs.

A hard-coated antiglare film is used in which a thin hard-coating antiglare layer with a thickness of 2 to 10 μm has been formed on one or both surfaces of a transparent plastic film substrate. The hard-coating antiglare layer is formed using hard-coating resins for forming a hard-coating antiglare layer such as thermosetting resins or ultraviolet(UV)-curable resins and fine particles. The surface of the hard-coating antiglare layer is provided with unevenness by the fine particles so as to provide antiglare properties. If such hard-coating resins are applied to a glass plate to form the hard-coating antiglare layer, it can exhibit a pencil hardness of 4H or more. If a hard-coating antiglare layer with an insufficient thickness is formed on a transparent plastic film substrate, however, the pencil hardness of the layer can be generally affected by the substrate and reduced to 3H or less.

LCD applications have come to include home television sets, and thus it is easily expected that the users of general home television sets should handle LCD television sets in the same manner as in the case of conventional glass CRT television sets. Glass CRTs have a pencil hardness of about 9H. Thus, hard-coated antiglare films to be used for LCDs have been required to have higher hardness.

An increase in the hardness of hard-coated antiglare films is possible by increasing the thickness of their hard-coating antiglare layer. However, the increase in layer thickness can cause a problem in that the particles are completely buried in the hard-coating antiglare layer and cannot provide sufficient antiglare properties. The amount of the fine particles may be increased to improve the antiglare properties, but in such a method, the number of the particles is increased in the layering direction, which causes a problem of high haze value. Recently, therefore, methods for overcoming the drawbacks of trying to achieve high hardness of hard-coated films, such as antiglare properties and increase in haze value, have been proposed, as disclosed in Japanese Patent Application Laid-Open (JP-A) Nos. 11-286083, 2000-326447, 2001-194504, and 2001-264508. Furthermore, JP-A No. 2003-4903 describes an antiglare film that prevents a failure due to glare from occurring with respect to a high definition image display with a small pixel size.

JP-A No. 11-286083 discloses a hard-coated antiglare film comprising a transparent substrate film and a hard-coating antiglare layer that is formed on the transparent substrate film and mainly composed of particles with a weight average particle size of 0.6 to 20 μm, fine particles with a weight average particle size of 1 to 500 nm and a hard-coating antiglare resin. It also discloses that the thickness of the hard-coating antiglare layer is at most the particle size of the particles, preferably at most 80% of the weight average particle size (specifically at most 16 μm).

JP-A No. 2000-326447 discloses a hard-coated film comprising a plastic substrate film and at least one hard-coating antiglare layer formed on at least one surface of the plastic substrate film, wherein the hard-coating antiglare layer has a thickness of 3 to 30 μm, and the hard-coating antiglare layer contains inorganic fine particles with secondary particle sizes of at most 20 μm. It also discloses that the surface of the hard-coating antiglare layer is provided with unevenness so as to provide antiglare properties.

JP-A No. 2001-194504 discloses an antireflection film comprising a plastic film and a laminate that is formed on at least one surface of the plastic film and comprises a hard-coating layer and thin antireflection film layer mainly composed of a metal alkoxide and a hydrolysate thereof, wherein the hard-coating antiglare layer has an elastic modulus of 0.7 to 5.5 GPa or lower at its breaking strain. It also discloses that the hard-coating antiglare layer has a thickness of 0.5 to 20 μm and that the hard-coating antiglare layer contains fine particles with a weight average particle size of 0.01 to 10 μm.

JP-A No. 2001-264508 discloses an antiglare antireflection film comprising a transparent support and a laminate that is formed on the transparent support and sequentially comprises a hard-coating antiglare layer containing particles with a weight average particle size of 1 to 10 μm and a low-refractive-index layer with a refractive index of 1.35 to 1.49 produced with a composition containing inorganic fine particles with a weight average particle size of 0.001 to 0.2 μm, a hydrolysate of a photo-curable organosilane and/or a partial condensate thereof, and a fluoropolymer, wherein the antiglare antireflection film has a haze value of 3 to 20% and an average reflectance of at most 1.8% at wavelengths of 450 nm to 650 nm. It also discloses that the hard-coating antiglare layer has a thickness of 1 to 10 μm.

JP-A No. 2003-4903 discloses, as an antiglare film that prevents a failure due to glare from occurring with respect to a high definition image display with a small pixel size, an antiglare film that has an antiglare layer on a transparent support and unevenness formed of concave and convex portions at the surface thereof. The antiglare film is characterized in that a cut surface of each concave portion has an area of 1000 μm² or smaller. It also discloses that in the antiglare film, the arithmetic average surface roughness Ra is in the range of 0.05 to 1.0 μm, while the average tilt angle θa of concave portions is not more than 20°.

However, in such conventional hard-coated antiglare films, problems in both hardness and antiglare properties have not been solved satisfactorily. In JP-A No. 11-286083, there is a problem in that when the hard-coating antiglare layer has a thickness approximately in the above-mentioned range, a sufficiently high hardness cannot be obtained. In JP-A No. 2000-326447, there is the following problem. That is, in such a structure as described above, no consideration is given to the surface roughness of the hard-coating antiglare layer surface, and when the structure allows the inorganic fine particles to be buried completely in the hard-coating antiglare layer, sufficiently high antiglare properties cannot be obtained. Although the antireflection film as described in JP-A No. 2001-194504 has improved hardness and scratch resistance, there is a problem in that for example, when fine particles with a weight average particle size of about 1.8 μm are added to a hard-coating antiglare layer with a thickness of about 20 μm, fine particles are buried completely in the hard-coating antiglare layer and cannot provide sufficiently high antiglare properties. The antiglare antireflection film as described in JP-A No. 2001-264508 is intended to improve the scratch resistance, antiglare properties, etc., but there is a problem in that a sufficiently high hardness is not obtained. In the hard-coated antiglare films described in JP-A Nos. 11-286083, 2000-326447, 2001-194504, 2001-264508, and 2003-4903, there is a problem of so-called white blur in the oblique directions in that light reflected by the film scatters excessively and the surface thereof looks white and blurred when viewed from oblique directions.

### SUMMARY OF THE INVENTION

With such problems in mind, the present invention is intended to provide a hard-coated antiglare film, a polarizing plate and an image display each including the hard-coated antiglare film used therein, and a method of manufacturing a hard-coated antiglare film. The hard-coated antiglare film has high hardness and excellent antiglare properties and prevents white blur from occurring when viewed from oblique directions.

In order to achieve the aforementioned object, a hard-coated antiglare film of the invention includes a transparent plastic film substrate and a hard-coating antiglare layer that is formed of fine particles and a hard-coating resin on at least one surface of the transparent film substrate. The hard-coating antiglare layer has a thickness of 15 to 30 μm. The fine particles have a weight average particle size of 30 to 75% of a thickness of the hard-coating antiglare layer. In the unevenness of the hard-coating antiglare layer surface, an average tilt angle θa is 1.0° to 2.0°, and an arithmetic average surface roughness Ra according to JIS B 0601 (1994 version) is 0.12 to 0.30 μm.

A polarizing plate of the present invention includes a polarizer and the hard-coated antiglare film of the present invention.

An image display of the present invention includes a hard-coated antiglare film of the present invention or a polarizing plate of the present invention.

A manufacturing method of the present invention is a method of manufacturing a hard-coated antiglare film including a transparent plastic film substrate and a hard-coating antiglare layer formed on at least one surface of the transparent plastic film. The method includes: preparing a material for forming the hard-coating antiglare layer containing fine particles, hard-coating resin, and a solvent; forming a coating film by applying the material for forming the hard-coating antiglare layer onto at least one surface of the transparent plastic film substrate, and forming a hard-coating layer by curing the coating film. The hard-coating antiglare layer has a thickness of 15 to 30 μm. The fine particles have a weight average particle size of 30 to 75% of a thickness of the hard-coating layer. The solvent contains ethyl acetate at a ratio of at least 50% by weight of the total amount. In the unevenness of the hard-coating antiglare layer surface, an average tilt angle θa is 1.0° to 2.0°, and an arithmetic average surface roughness Ra according to JIS B 0601 (1994 version) is 0.12 to 0.30 μm.

The hard-coated antiglare film of the present invention is allowed to have an increased hardness since the thickness of the hard-coating antiglare layer is set in the aforementioned range. In the hard-coated antiglare film of the present invention, the weight average particle size of the fine particles is set in the aforementioned predetermined range, while in the unevenness of the hard-coating antiglare layer surface, the average tilt angle θa and the arithmetic average surface roughness Ra are set in the aforementioned predetermined ranges. Accordingly, the hard-coated antiglare film of the present invention has excellent antiglare properties and can effectively prevent white blur from occurring when viewed from oblique directions. Hence, an image display provided with a hard-coated antiglare film of the present invention and a polarizing plate including the same used therein has the following effects, for example. That is, it has excellent handling properties due to suitable protection of its screen, excellent antiglare properties, and excellent display characteristics, with white blur being prevented from occurring when viewed from oblique directions. Such a high-performance hard-coated antiglare film of the present invention can be manufactured by the manufacturing method of the present invention. However, the hard-coated antiglare film of the present invention may be manufactured by other manufacturing methods. In the manufacturing method of the present invention, since the solvent to be used therein contains ethyl acetate at a ratio of at least 50% by weight of the total amount, a high adhesiveness is obtained between the hard-coating antiglare layer to be formed and the transparent plastic film substrate.

### BRIEF DESCRIPTION OF THE DRAWINGS

FIG. 1 is a cross-sectional view schematically showing the structure of a hard-coated antiglare film according to one embodiment of the present invention;

FIG. 2 is a cross-sectional view schematically showing the structure of a hard-coated antiglare film according to another embodiment of the present invention;

FIG. 3 is a schematic view showing an example of the relationship among the roughness curve, height h, and standard length L and

FIG. 4 is a schematic view showing an example of the method of evaluating white blur that occurs when a hard-coated antiglare film is viewed from oblique directions.

### DESCRIPTION OF THE EMBODIMENTS

Preferably, in the hard-coated antiglare film and the method of manufacturing the same of the present invention, the fine particles are of a plurality of types that include at least two types of fine particles whose weight average particle sizes are different from each other, and at least one of the plurality of types of fine particles has a weight average particle size in the range of 30 to 75% of the thickness of the hard-coating antiglare layer.

Preferably, in the hard-coated antiglare film and the method of manufacturing the same of the present invention, the fine particles each have a spherical shape.

In the hard-coated antiglare film of the present invention, glossiness according to JIS K 7105 (1981 version) is preferably at most 60. Similarly, in the method of manufacturing a hard-coated antiglare film of the present invention, it is preferable that the hard-coating antiglare layer be formed in such a manner that the resulting hard-coated antiglare film has a glossiness according to JIS K 7105 of at most 60. The aforementioned term “glossiness” means the 60-degree specular gloss according to JIS K 7105 (1981 version).

In the hard-coated antiglare film and the method of manufacturing the same of the present invention, it is preferable that the hard-coating resin contains Component A, Component B, and Component C described below:

### Component A: at least one of urethane acrylate and urethane methacrylate;

### Component B: at least one of polyol acrylate and polyol methacrylate; and

### Component C: a polymer or copolymer that is formed of at least one of Components C1 and C2 described below, or a mixed polymer of the polymer and the copolymer,

### Component C1: alkyl acrylate having an alkyl group containing at least one of a hydroxyl group and an acryloyl group, and

### Component C2: alkyl methacrylate having an alkyl group containing at least one of a hydroxyl group and an acryloyl group.

Preferably, in the hard-coated antiglare film of the present invention, further comprising an antireflection layer formed on the hard-coating antiglare layer. The antireflection layer preferably contains hollow spherical silicon oxide ultrafine particles.

Next, the present invention is described in detail. The present invention, however, is not limited by the following description.

The hard-coated antiglare film of the present invention includes a transparent plastic film substrate and a hard-coating antiglare layer formed on one or both surfaces of the transparent plastic film substrate.

The transparent plastic film substrate is not particularly limited. Preferably, the transparent plastic film substrate has a high visible-light transmittance (preferably a light transmittance of at least 90%) and good transparency (preferably a haze value of at most 1%). Examples of the material for forming the transparent plastic film substrate include polyester type polymers, cellulose type polymers, polycarbonate type polymers, acrylics type polymers, etc. Examples of the polyester type polymers include polyethylene terephthalate, polyethylenenaphthalate, etc. Examples of the cellulose type polymers include diacetyl cellulose, triacetyl cellulose (TAC), etc. Examples of the acrylic type polymers include poly methylmethacrylate, etc. Examples of the material for forming the transparent plastic film substrate also include styrene type polymers, olefin type polymers, vinyl chloride type polymers, amide type polymers, etc. Examples of the styrene type polymers include polystyrene, acrylonitrile-styrene copolymer, etc. Examples of the olefin type polymers include polyethylene, polypropylene, polyolefin that has a cyclic or norbornene structure, ethylene-propylene copolymer, etc. Examples of the amide type polymers include nylon, aromatic polyamide, etc. The material for forming the transparent plastic film substrate also contains, for example, imide type polymers, sulfone type polymers, polyether sulfone type polymers, polyether-ether ketone type polymers, poly phenylene sulfide type polymers, vinyl alcohol type polymers, vinylidene chloride type polymers, vinyl butyral type polymers, allylate type polymers, polyoxymethylene type polymers, epoxy type polymers, blend polymers of the above-mentioned polymers, etc. Among them, those having small optical birefringence are used suitably. The hard-coated antiglare film of the present invention can be used as a protective film for a polarizing plate, for example. In such a case, the transparent plastic film substrate is preferably a film formed of triacetyl cellulose, polycarbonate, an acrylic polymer, a polyolefin having a cyclic or norbornene structure, etc. In the present invention, as described below, the transparent plastic film substrate may be a polarizer itself. Such a structure does not need a protective layer of TAC or the like and provides a simple polarizing plate structure and thus allows a reduction in the number of steps for manufacturing polarizing plates or image displays and an increase in production efficiency. In addition, such a structure can provide thinner polarizing plates. When the transparent plastic film substrate is a polarizer, the hard-coating layer serves as a protective layer in a conventional manner. In such a structure, the hard-coated film also functions as a cover plate, when attached to the surface of a liquid crystal cell.

In the present invention, the thickness of the transparent plastic film substrate is not particularly limited. For example, the thickness is preferably 10 to 500 μm, more preferably 20 to 300 μm, and most suitably 30 to 200 μm, in terms of strength, workability such as handling property, and thin layer property.

The hard-coating antiglare layer is formed using the fine particles and the hard-coating resin.

As described above, the hard-coating resin, for example, contains Component A, Component B, and Component C described below:

### Component A: at least one of urethane acrylate and urethane methacrylate;

### Component B: at least one of polyol acrylate and polyol methacrylate; and

### Component C: a polymer or copolymer that is formed of at least one of Components C1 and C2 described below, or a mixed polymer of the polymer and the copolymer,

### Component C1: alkyl acrylate having an alkyl group containing at least one of a hydroxyl group and an acryloyl group, and

### Component C2: alkyl methacrylate having an alkyl group containing at least one of a hydroxyl group and an acryloyl group.

Examples of the urethane acrylate and urethane methacrylate of Component A include those containing constituents such as acrylic acid, methacrylic acid, acrylic acid ester, methacrylic acid ester, a polyol, and a diisocyanate. For example, at least one of the urethane acrylate and urethane methacrylate can be produced by using a polyol and at least one monomer selected from acrylic acid, methacrylic acid, acrylic acid ester, and methacrylic acid ester, preparing at least one of a hydroxyacrylate having at least one hydroxyl group and a hydroxymethacrylate having at least one hydroxyl group, and allowing it to react with a diisocyanate. In Component A, one type of urethane acrylate or urethane methacrylate may be used alone, or two types or more of them may be used in combination.

Examples of the acrylic acid ester include alkyl acrylates, cycloalkyl acrylates, etc. Examples of the alkyl acrylates include methyl acrylate, ethyl acrylate, isopropyl acrylate, butyl acrylate, etc. Examples of the cycloalkyl acrylates include cyclohexyl acrylate, etc. Examples of the methacrylic acid ester include alkyl methacrylates, cycloalkyl methacrylates, etc. Examples of the alkyl methacrylates include methyl methacrylate, ethyl methacrylate, isopropyl methacrylate, butyl methacrylate, etc. Examples of the cycloalkyl methacrylates include cyclohexyl methacrylate, etc.

The polyol is a compound having at least two hydroxyl groups. Examples of the polyol include ethylene glycol, 1,3-propylene glycol, 1,2-propylene glycol, diethylene glycol, dipropylene glycol, neopentyl glycol, 1,3-butanediol, 1,4-butanediol, 1,6-hexanediol, 1,9-nonanediol, 1,10-decanediol, 2,2,4-trimethyl-1,3-pentanediol, 3-methyl-1,5-pentanediol, neopentylglycol hydroxypivalate ester, cyclohexane dimethylol, 1,4-cyclohexanediol, spiroglycol, tricyclodecane methylol, hydrogenated bisphenol A, ethylene oxide-added bisphenol A, propylene oxide-added bisphenol A, trimethylolethane, trimethylolpropane, glycerin, 3-methylpentane-1,3,5-triol, pentaerythritol, dipentaerythritol, tripentaerythritol, glucoses, etc.

The diisocyanate to be used herein can be any type of aromatic, aliphatic, or alicyclic diisocyanate. Examples of the diisocyanate include tetramethylene diisocyanate, hexamethylene diisocyanate, isophorone diisocyanate, 2,4-tolylene diisocyanate, 4,4-diphenyl diisocyanate, 1,5-naphthalene diisocyanate, 3,3-dimethyl-4,4-diphenyl diisocyanate, xylene diisocyanate, trimethyl hexamethylene diisocyanate, 4,4-diphenylmethane diisocyanate, and hydrogenated derivatives thereof.

The ratio of Component A to be added is not particularly limited. The use of Component A can improve the flexibility of the resulting hard-coating antiglare layer and adhesion of the resulting hard-coating antiglare layer with respect to the transparent plastic film substrate. From such viewpoints and the viewpoint of hardness of the hard-coating antiglare layer, the ratio of Component A to be added is, for example, 15 to 55% by weight, preferably 25 to 45% by weight, with respect to the entire resin components in the material for forming the hard-coating antiglare layer. The term “entire resin components” denotes the total amount of Components A, B, and C, or when other resin components are used, a sum of the total amount of the aforementioned three components and the total amount of the resin components. The same applies below.

Examples of Component B include pentaerythritol diacrylate, pentaerythritol triacrylate, pentaerythritol tetraacrylate, dipentaerythritol hexaacrylate, 1,6-hexanediol acrylate, pentaerythritol dimethacrylate, pentaerythritol trimethacrylate, pentaerythritol tetramethacrylate, dipentaerythritol hexamethacrylate, 1,6-hexanediol methacrylate, etc. These can be used alone. Two or more of them can be used in combination. Preferred examples of the polyol acrylate include a monomer component containing a polymer of pentaerythritol triacrylate and pentaerythritol tetraacrylate, and a component mixture containing pentaerythritol triacrylate and pentaerythritol tetraacrylate.

The ratio of Component B to be added is not particularly limited. The ratio of Component B to be added is preferably 70 to 180% by weight and more preferably 100 to 150% by weight, with respect to the amount of Component A. When the ratio of Component B to be added is 180% by weight or less with respect to the amount of Component A, the hard-coating antiglare layer to be formed can be effectively prevented from hardening and shrinking. As a result, the hard-coated antiglare film can be prevented from curling and the flexibility thereof can be prevented from deteriorating. When the ratio of Component B to be added is at least 70% by weight with respect to the amount of Component A, the hard-coating antiglare layer to be formed can have further improved hardness and improved scratch resistance.

In Component C, the alkyl groups of Components C1 and C2 are not particularly limited, for instance, the alkyl groups with a carbon number of 1 to 10. The alkyl groups can be of a straight chain. The alkyl groups can be of a branched-chain. For example, Component C can contain a polymer or copolymer containing a repeating unit represented by General Formula (1) indicated below, or a mixture of the polymer and the copolymer.

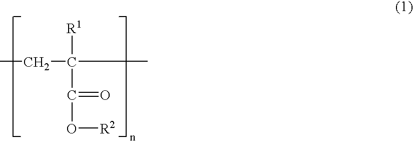

In General Formula (1), R¹ denotes —H or —CH₃, R² denotes —CH₂CH₂OX or a group that is represented by General Formula (2) indicated below, and the X denotes —H or an acryloyl group that is represented by General Formula (3) indicated below.

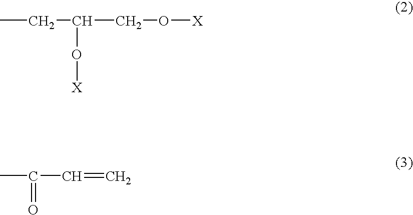

### In General Formula (2), the X denotes —H or an acryloyl group that is represented by General Formula (3), and Xs are identical to or different from each other.

Examples of Component C include a polymer, a copolymer, and a mixture of the polymer and the copolymer, with the polymer and a copolymer being formed of at least one monomer selected from the group consisting of 2,3-dihydroxypropyl acrylate, 2,3-diacryloyloxypropyl acrylate, 2-hydroxy-3-acryloyloxypropyl acrylate, 2-acryloyloxy-3-hydroxypropyl acrylate, 2,3-dihydroxypropyl methacrylate, 2,3-diacryloyloxypropyl methacrylate, 2-hydroxy-3-acryloyloxypropyl methacrylate, 2-acryloyloxy-3-hydroxypropyl methacrylate, 2-hydroxyethyl acrylate, 2-acryloyloxyethyl acrylate, 2-hydroxyethyl methacrylate, and 2-acryloyloxyethyl methacrylate.

The ratio of Component C to be added is not particularly limited. For instance, the ratio of Component C to be added is preferably 25 to 110% by weight and more preferably 45 to 85% by weight, with respect to the amount of Component A. When the ratio of Component C to be added is 110% by weight or lower with respect to the amount of Component A, the material for forming the hard-coating antiglare layer has excellent coating properties. When the ratio of Component C to be added is at least 25% by weight with respect to the amount of Component A, the hard-coating antiglare layer to be formed can be prevented from hardening and shrinking. As a result, in the hard-coated antiglare film, curling can be controlled.

The fine particles used for forming the hard-coating antiglare layer serve mainly for providing the hard-coating antiglare layer with antiglare properties by forming unevenness at the resulting hard-coating antiglare layer surface. The fine particles can be inorganic or organic fine particles, for example. The inorganic fine particles are not particularly limited. Examples of the inorganic fine particles include fine particles made of silicon oxide, titanium oxide, aluminum oxide, zinc oxide, tin oxide, calcium carbonate, barium sulfate, talc, kaolin, calcium sulfate, etc. The organic fine particles are not particularly limited. Examples thereof include polymethyl methacrylate acrylate resin powder (PMMA fine particles), silicone resin powder, polystyrene resin powder, polycarbonate resin powder, acrylic-styrene resin powder, benzoguanamine resin powder, melamine resin powder, polyolefin resin powder, polyester resin powder, polyamide resin powder, polyimide resin powder, polyethylene fluoride resin powder, etc. One type of the inorganic and organic fine particles can be used alone. Alternatively, two types or more of them can be used in combination.

The weight average particle size of the fine particles is in the range of 30 to 75%, preferably 30 to 50%, of the thickness of the hard-coating antiglare layer. When the weight average particle size of the fine particles is at least 30%, the hard-coating antiglare layer surface can be provided with sufficient unevenness and thereby a sufficiently high antiglare function can be provided. When the weight average particle size of the fine particles is at most 75%, the surface can have a suitable difference between concave portions and convex portions of the unevenness, the appearance can be improved, and reflected light is allowed to scatter suitably and thereby white blur can be prevented from occurring. In the present invention, the weight average particle size of the fine particles is, for example, in the range of 4.5 to 22.5 μm, preferably 5.4 to 18.8 μm, and more preferably 5.4 to 12.5 μm. The weight average particle size of the fine particles can be measured by a Coulter counting method, for example. For the measurement of the weight average particle size of the fine particles, for instance, a particle size distribution measurement apparatus (trade name: Coulter Multisizer, manufactured by Beckman Coulter, Inc.) using a pore electrical resistance method is used to measure electrical resistance of an electrolyte corresponding to the volumes of the fine particles when the fine particles pass through the pores. Thus the number and volume of the fine particles are measured and then the weight average particle size is calculated.

The shape of the fine particles is not particularly limited. The fine particles can be in the form of substantially spherical beads or may be of an indefinite shape such as powder, for instance. As described above, in the present invention, the fine particles are preferably of plural types with at least two different weight average particle sizes. This means that there are at least two groups (fine particle powder) each including a plurality of fine particles having one weight average particle size. As described above, the fine particles preferably have a substantially spherical shape, more preferably a substantially spherical shape with an aspect ratio of at most 1.5. This is because when the aspect ratio is at most 1.5, in the unevenness of the hard-coating antiglare layer surface, the arithmetic average surface roughness Ra and the average tilt angle θa can be controlled more preferably. The aspect ratio is more preferably smaller than 1.05.

The ratio of the fine particles to be added is not particularly limited but can be determined suitably. With respect to 100 parts by weight of the entire resin components, the ratio of the fine particles to be added is, for instance, 2 to 70 parts by weight, preferably 4 to 50 parts by weight, more preferably 15 to 40 parts by weight.

From the viewpoints of preventing the occurrence of interference fringes or light scattering that is caused at the interfaces between the hard-coating antiglare layer and the fine particles, it is preferable that the difference in refractive index between the fine particles and the hard-coating antiglare layer be reduced. Prevention of light scattering mentioned above also can prevent white blur from occurring. Since the refractive index of the hard-coating layer is generally in the range of 1.4 to 1.6, the fine particles have preferably refractive indices close to the above-mentioned refractive index range. Preferably, the difference in refractive index between the fine particles and the hard-coating layer is smaller than 0.05.

In the unevenness of the hard-coating antiglare layer surface, the average tilt angle θa is in the range of 1.0° to 2.0°, while the arithmetic average surface roughness Ra is in the range of 0.12 to 0.30 μm. When the average tilt angle θa is smaller than 1.0° or the arithmetic average surface roughness Ra is less than 0.12 μm, sufficiently high antiglare properties cannot be obtained and thereby reflection of external light, etc. occurs, which is a disadvantage. On the other hand, when the average tilt angle θa exceeds 2.0° or the arithmetic average surface roughness Ra exceeds 0.30 μm, white blur in the oblique directions occurs, which is a problem. The average tilt angle θa is preferably in the range of 1.1° to 1.8°, more preferably in the range of 1.2° to 1.6°. The arithmetic average surface roughness Ra is preferably in the range of 0.15 to 0.28 μm, more preferably in the range of 0.16 to 0.27 μm. In the present invention, the arithmetic average surface roughness Ra and the average tilt angle θa can be adjusted by suitably selecting the type of hard coating resin, the thickness of the hard-coating antiglare layer, the type of fine particles, the weight average particle size of the fine particles, etc. Any person skilled in the art can obtain the arithmetic average surface roughness Ra and the average tilt angle θa in the predetermined ranges of the present invention without carrying out an excessive amount of trial and error.

In the present invention, the average tilt angle θa is a value defined by Expression (1) indicated below. The average tilt angle θa is a value measured by the method described later in the section of Examples.

Average tilt angle θa=tan⁻Δa (1)

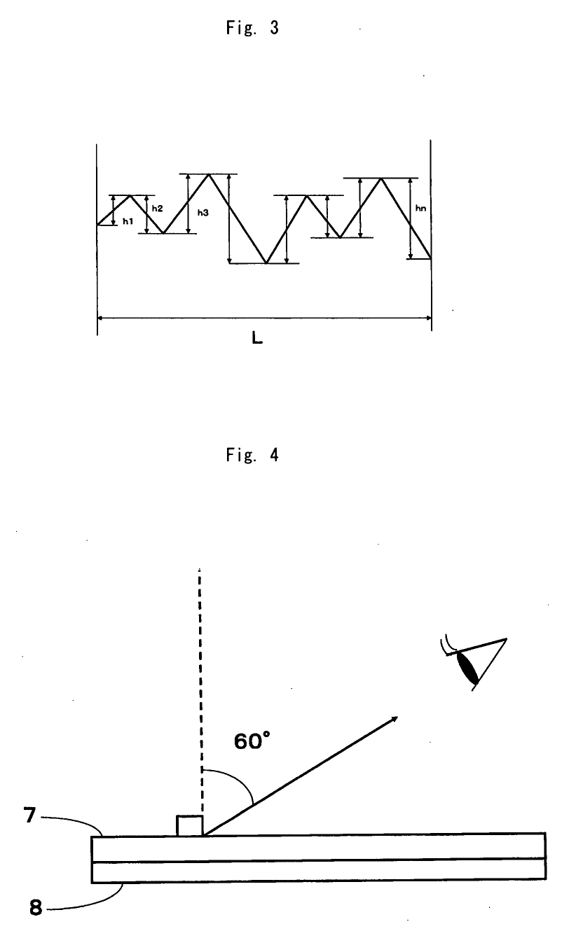

In Expression (1) described above, as indicated in Expression (2) below, Δa denotes a value obtained by dividing the sum total (h1+h2+h3 . . . +hn) of the differences (heights h) between adjacent peaks and the lowest point of the trough formed therebetween by the standard length L of the roughness curve defined in JIS B 0601 (1994 version). The roughness curve is a curve obtained by removing the surface waviness components with longer wavelengths than the predetermined one from the profile curve using a retardation compensation high-pass filter. The profile curve denotes a profile that appears at the cut surface when an object surface was cut in a plane perpendicular to the object surface. FIG. 3 shows examples of the roughness curve, height h, and standard line L.

Δa=(h1+h2+h3 . . . +hn)/L (2)

The arithmetic average surface roughness Ra is referred to also as “arithmetic average roughness Ra”. It is one of the indices for expressing the surface roughness of an object and is one that is defined in JIS B 0601 (1994 version). The arithmetic average surface roughness Ra can be measured by, for instance, the method described later in the section of Examples.

The difference din refractive index between the transparent plastic film substrate and the hard-coating antiglare layer is preferably at most 0.04. When the difference d is at most 0.04, the interference fringes can be prevented from occurring. The difference d is more preferably at most 0.02.

The thickness of the hard-coating antiglare layer is in the range of 15 to 30 μm. When the thickness is in the aforementioned predetermined range, the hard-coating antiglare layer has sufficiently high hardness (for example, a pencil hardness of at least 4H), has excellent antiglare properties while having suitable surface unevenness, and can prevent white blur from occurring in oblique directions. The thickness of the hard-coating antiglare layer is preferably in the range of 18 to 25 μm.

The hard-coated antiglare film of the present invention can be manufactured by, for example, preparing a material for forming a hard-coating antiglare layer including the fine particles, the hard-coating resin and a solvent; forming a coating film by applying the material for forming the hard-coating antiglare layer onto at least one surface of the transparent plastic film substrate; and forming the hard-coating antiglare layer by curing the coating film.

The solvent is not particularly limited. Examples of the solvent include dibutyl ether, dimethoxymethane, dimethoxyethane, diethoxyethane, propylene oxide, 1,4-dioxane, 1,3-dioxolane, 1,3,5-trioxane, tetrahydrofuran, acetone, methyl ethyl ketone, diethyl ketone, dipropyl ketone, diisobutyl ketone, cyclopentanone, cyclohexanone, methylcyclohexanone, ethyl formate, propyl formate, n-pentyl formate, methyl acetate, ethyl acetate, methyl propionate, ethyl propionate, n-pentyl acetate, acetyl acetone, diacetone alcohol, methyl acetoacetate, ethyl acetoacetate, methanol, ethanol, 1-propanol, 2-propanol, 1-butanol, 2-butanol, 1-pentanol, 2-methyl-2-butanol, cyclohexanol, isobutyl acetate, methyl isobutyl ketone (MIBK), 2-octanone, 2-pentanone, 2-hexanone, 2-heptanone, 3-heptanone, ethylene glycol monoethyl ether acetate, ethylene glycol monoethyl ether, ethylene glycol monobutyl ether, ethylene glycol monomethyl ether, propylene glycol monomethyl ether acetate, propylene glycol monomethyl ether, etc. One of these solvents or any combination of two or more of these solvents may be used. From the viewpoints of improving the adhesion between the transparent plastic film substrate and the hard-coating antiglare layer, the solvent contains ethyl acetate whose ratio to the whole is preferably at least 50% by weight, more preferably at least 60% by weight, and most preferably at least 70% by weight. The type of the solvent to be used in combination with the ethyl acetate is not particularly limited. Examples of the solvent include butyl acetate, methyl ethyl ketone, ethylene glycol monobutyl ether, propylene glycol monomethyl ether, etc.

Various types of leveling agents can be added to the material for forming a hard-coating antiglare layer. The leveling agent may be, for example, a fluorochemical or silicone leveling agent, preferably a silicone leveling agent. Examples of the silicon leveling agent include a reactive silicone, polydimethylsiloxane, polyether-modified polydimethylsiloxane, polymethylalkylsiloxane, etc. Among these silicone leveling agents, the reactive silicone is particularly preferred. The reactive silicone added can impart lubricity to the surface and produce continuous scratch resistance over a long period of time. As described below, in the case of using a reactive silicone containing a hydroxyl group, when an antireflection layer (a low refractive index layer) containing a siloxane component is formed on the hard-coating antiglare layer, the adhesion between the antireflection layer and the hard-coating antiglare layer is improved.

The amount of the leveling agent to be added is, for example, at most 5 parts by weight, preferably in the range of 0.01 to 5 parts by weight, with respect to 100 parts by weight of all the resin components.

If necessary, the material for forming a hard-coating antiglare layer may contain a pigment, a filler, a dispersing agent, a plasticizer, an ultraviolet absorbing agent, a surfactant, an antioxidant, a thixotropy-imparting agent, or the like, as long as the performance is not degraded. One of these additives may be used alone, or two or more of these additives may be used together.

The material for forming a hard-coating antiglare layer can contain any conventionally known photopolymerization initiator. Examples of the applicable photopolymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N, N,N′,N′-tetramethyl-4,4′-diaminobenzophenone, 1-(4-isopropylphenyl)-2-hydroxy-2-methylpropane-1-one, and other thioxanthone compounds.

The material for forming a hard-coating antiglare layer may be applied onto the transparent plastic film substrate by any coating method such as fountain coating, die coating, spin coating, spray coating, gravure coating, roll coating, bar coating, etc.

The material for forming a hard-coating antiglare layer is applied to form a coating film on the transparent plastic film substrate and then the coating film is cured. Preferably, the coating film is dried before being cured. The drying can be carried out by, for instance, allowing it to stand, air drying by blowing air, drying by heating, or a combination thereof.

While the coating film formed of the material for forming a hard-coating antiglare layer may be cured by any method, ionizing radiation curing is preferably used. While any type of activation energy may be used for such curing, ultraviolet light is preferably used. Preferred examples of the energy radiation source include high-pressure mercury lamps, halogen lamps, xenon lamps, metal halide lamps, nitrogen lasers, electron beam accelerators, and radioactive elements. The amount of irradiation with the energy radiation source is preferably 50 to 5000 mJ/cm² in terms of accumulative exposure at an ultraviolet wavelength of 365 nm. When the amount of irradiation is at least 50 mJ/cm², the material for forming a hard-coating antiglare layer can be cured further sufficiently and the resulting hard-coating antiglare layer also has a sufficiently higher hardness. When the amount of irradiation is at most 5000 mJ/cm², the resulting hard-coating antiglare layer can be prevented from being colored and thereby can have improved transparency.

As described above, a hard-coated antiglare film of the present invention can be manufactured by forming the hard-coating antiglare layer on at least one surface of the transparent plastic film substrate. The hard-coated antiglare film of the present invention can be manufactured by manufacturing methods other than that described above. The hard-coated antiglare film of the present invention has a pencil hardness of at least 4H, for example.

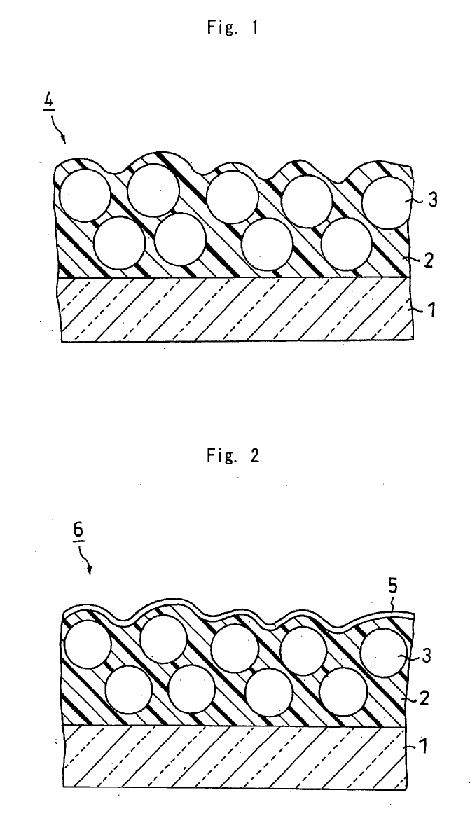

FIG. 1 is a cross-sectional view schematically showing an example of the hard-coated antiglare film of the present invention. As shown in FIG. 1, a hard-coated antiglare film 4 in this example includes a transparent plastic film substrate 1 and a hard-coating antiglare layer 2 is formed on one surface of the transparent plastic film substrate 1. The hard-coating antiglare layer 2 contains fine particles 3 and the surface of the hard-coating antiglare layer 2 is provided with unevenness by the fine particles 3. In this example, the hard-coating antiglare layer 2 is formed on one surface of the transparent plastic film substrate 1. However, the present invention is not limited to this. A hard-coated antiglare film can include a transparent plastic film substrate 1 and hard-coating antiglare layers 2, each of which is formed on each surface of the transparent plastic film substrate 1. The hard-coating antiglare layer 2 in this example is monolayer. However, the present invention is not limited to this. The hard-coating antiglare layer 2 may have a multilayer structure in which two or more layers are stacked together.

In the hard-coated antiglare film of the present invention, an antireflection layer (a low refractive index layer) may be formed on the hard-coating antiglare layer. FIG. 2 is a cross-sectional view schematically showing an example of a hard-coated antiglare film of the present invention including the antireflection layer. As shown in FIG. 2, a hard-coated antiglare film 6 in this example has a structure in which a hard-coating antiglare layer 2 contains fine particles 3 and is formed on one surface of the transparent plastic film substrate 1 and an antireflection layer 5 is formed on the hard-coating antiglare layer 2. Light incident on an object undergoes reflection at the interface, absorption and scattering in the interior, and any other phenomena repeatedly until it goes through the object and reaches the back side. For example, light reflection at the interface between air and a hard-coating antiglare layer is one of the factors in the reduction in visibility of the image on an image display equipped with the hard-coated antiglare film. The antireflection layer reduces such surface reflection. In the hard-coated antiglare film 6 shown in FIG. 2, the hard-coating antiglare layer 2 and the antireflection layer 5 are formed on one surface of the transparent plastic film substrate 1. However, the present invention is not limited to this. In a hard-coated antiglare film of the present invention, the hard-coating antiglare layer 2 and the antireflection layer 5 may be formed on both surfaces of the transparent plastic film substrate 1. In the hard-coated antiglare film 6 shown in FIG. 2, the hard-coating antiglare layer 2 and the antireflection layer 5 each are a monolayer. However, the present invention is not limited to this. The hard-coating antiglare layer 2 and the antireflection layer 5 each may have a multilayer structure in which at least two layers are stacked together.

In the present invention, the antireflection layer is a thin optical film having a strictly controlled thickness and refractive index, or a laminate including at least two layers of the thin optical films that are stacked together. In the antireflection layer, the antireflection function is produced by allowing opposite phases of incident light and reflected light to cancel each other out based on interference of light. The antireflection function should be produced in the visible light wavelength range of 380 to 780 nm, and the visibility is particularly high in the wavelength range of 450 to 650 nm. Preferably, the antireflection layer is designed to have a minimum reflectance at the center wavelength 550 nm of the range.

When the antireflection layer is designed based on interference of light, the interference effect can be enhanced by a method of increasing the difference in refractive index between the antireflection layer and the hard-coating antiglare layer. Generally, in an antireflection multilayer including two to five thin optical layers (each with strictly controlled thickness and refractive index) that are stacked together, components with different refractive indices from each other are used to form a plurality of layers with a predetermined thickness. Thus, the antireflection layer can be optically designed at a higher degree of freedom, the antireflection effect can be enhanced, and in addition, the spectral reflection characteristics can be made flat in the visible light range. Since each layer of the thin optical film must be precise in thickness, a dry process such as vacuum deposition, sputtering, CVD, etc. is generally used to form each layer.

For the antireflection multilayer, a two-layer laminate is preferred including a high-refractive-index titanium oxide layer (refractive index: about 1.8) and a low-refractive-index silicon oxide layer (refractive index: about 1.45) formed on the titanium oxide layer. A four-layer laminate is more preferable wherein a silicon oxide layer is formed on a titanium oxide layer, another titanium oxide is formed thereon, and then another silicon oxide layer is formed thereon. The formation of the antireflection layer of such a two- or four-layer laminate can evenly reduce reflection over the visible light wavelength range (for example, 380 to 780 nm).

The antireflection effect can also be produced by forming a thin monolayer optical film (an antireflection layer) on the hard-coating antiglare layer. The antireflection monolayer is generally formed using a coating method such as a wet process, for example, fountain coating, die coating, spin coating, spray coating, gravure coating, roll coating, or bar coating.

Examples of the material for forming an antireflection monolayer include: resin materials such as UV-curable acrylic resins; hybrid materials such as a dispersion of inorganic fine particles such as colloidal silica in a resin; and sol-gel materials containing metal alkoxide such as tetraethoxysilane and titanium tetraethoxide. Preferably, the material contains a fluorine group to impart anti-fouling surface properties. In terms of, for example, scratch resistance, the material preferably contains a large amount of an inorganic component, and the sol-gel materials are more preferable. Partial condensates of the sol-gel materials can be used.

The antireflection layer (the low-refractive-index layer) may contain an inorganic sol for increasing film strength. The inorganic sol is not particularly limited. Examples thereof include silica, alumina, magnesium fluoride, etc. Particularly, silica sol is preferred. The amount of the inorganic sol to be added is, for example, in the range of 10 to 80 parts by weight, based on 100 parts by weight of the total solids of the material for forming the antireflection layer. The size of the inorganic fine particles in the inorganic sol is preferably in the range of 2 to 50 nm, more preferably 5 to 30 nm.

The material for forming the antireflection layer preferably contains hollow spherical silicon oxide ultrafine particles. The silicon oxide ultrafine particles have preferably an average particle size of 5 to 300 nm, more preferably 10 to 200 nm. The silicon oxide ultrafine particles are in the form of hollow spheres each including a pore-containing outer shell in which a hollow is formed. The hollow contains at least one of a solvent and a gas that has been used for preparing the ultrafine particles. A precursor substance for forming the hollow of the ultrafine particle preferably remains in the hollow. The thickness of the outer shell is preferably in the range of about 1 to about 50 nm and in the range of approximately 1/50 to ⅕ of the average particle size of the ultrafine particles. The outer shell preferably includes a plurality of coating layers. In the ultrafine particles, the pore is preferably blocked, and the hollow is preferably sealed with the outer shell. This is because the antireflection layer holding a porous structure or a hollow of the ultrafine particles can have a reduced refractive index of the antireflection layer. The method of producing such hollow spherical silicon oxide ultrafine particles is preferably a method of producing silica fine particles as disclosed in JP-A No. 2000-233611, for example.

In the process of forming the antireflection layer (the low-refractive-index layer), while drying and curing may be performed at any temperature, they are performed at a temperature of, for example, 60 to 150° C., preferably 70 to 130° C., for a time period of, for instance, 1 minute to 30 minutes, preferably 1 minute to 10 minutes in view of productivity. After drying and curing, the layer may be further heated, so that a hard-coated antiglare film of high hardness including an antireflection layer can be obtained. While the heating may be performed at any temperature, it is performed at a temperature of, for example, 40 to 130° C., preferably 50 to 100° C., for a time period of, for instance, 1 minute to 100 hours, more preferably at least 10 hours in terms of improving scratch resistance. The temperature and the time period are not limited to the above range. The heating can be performed by a method using a hot plate, an oven, a belt furnace, or the like.

When the hard-coated antiglare film including the antireflection layer is attached to an image display, the antireflection layer may serve frequently as the uppermost surface and thus tends to be susceptible to stains from the external environment. Stains are more conspicuous on the antireflection layer than on, for instance, a simple transparent plate. In the antireflection layer, for example, deposition of stains such as fingerprints, thumbmarks, sweat, and hairdressings change the surface reflectance, or the deposition stands out whitely to make the displayed content unclear. Preferably, an antistain layer formed of a fluoro-silane compound, a fluoro-organic compound, or the like is layered on the antireflection layer in order to impart the functions of antideposition and easy elimination of the stains.

With respect to the hard-coated antiglare film of the present invention, it is preferable that at least one of the transparent plastic film substrate and the hard-coating antiglare layer be subjected to a surface treatment. When the surface treatment is performed on the transparent plastic film substrate, adhesion thereof to the hard-coating antiglare layer, the polarizer, or the polarizing plate further improves. When the surface treatment is performed on the hard-coating antiglare layer, adhesion thereof to the antireflection layer, the polarizer, or the polarizing plate further improves. The surface treatment can be, for example, a low-pressure plasma treatment, an ultraviolet radiation treatment, a corona treatment, a flame treatment, or an acid or alkali treatment. When a triacetyl cellulose film is used for the transparent plastic film substrate, an alkali treatment is preferably used as the surface treatment. This alkali treatment can be carried out by allowing the surface of the triacetyl cellulose film to come into contact with an alkali solution, washing it with water, and drying it. The alkali solution can be a potassium hydroxide solution or a sodium hydroxide solution, for example. The normal concentration (molar concentration) of the hydroxide ions of the alkali solution is preferably in the range of 0.1 N (mol/L) to 3.0 N (mol/L), more preferably 0.5 N (mol/L) to 2.0 N (mol/L).

In a hard-coated antiglare film including the transparent plastic film substrate and the hard-coating antiglare layer formed on one surface of the transparent plastic film substrate, for the purpose of preventing curling, the surface opposite to the surface with the hard-coating antiglare layer formed thereon may be subjected to a solvent treatment. The solvent treatment can be carried out by allowing the transparent plastic film substrate to come into contact with a dissolvable or swellable solvent. With the solvent treatment, the transparent plastic film substrate can have a tendency to curl toward the other surface, which can cancel the force allowing the transparent plastic film substrate with the hard-coating antiglare layer to curl toward the hard-coating layer side and thus can prevent curling. Similarly, in the hard-coated antiglare film including the transparent plastic film substrate and the hard-coating antiglare layer formed on one surface of the transparent plastic film substrate, for the purpose of preventing curling, a transparent resin layer may be formed on the other surface. The transparent resin layer is, for example, a layer that is mainly composed of a thermoplastic resin, a radiation-curable resin, a thermo-setting resin, or any other reactive resin. In particular, a layer mainly composed of a thermoplastic resin is preferred.

The transparent plastic film substrate side of the hard-coated antiglare film of the present invention is generally bonded to an optical component for use in a LCD or ELD via a pressure-sensitive adhesive or an adhesive. Before the bonding, the transparent plastic film substrate surface may also be subjected to various surface treatments as described above.

For example, the optical component can be a polarizer or a polarizing plate. A polarizing plate including a polarizer and a transparent protective film formed on one or both surfaces of the polarizer is commonly used. If the transparent protective film is formed on both surfaces of the polarizer, the front and rear transparent protective films may be made of the same material or different materials. Polarizing plates are generally placed on both surfaces of a liquid crystal cell. Polarizing plates may be arranged such that the absorption axes of two polarizing plates are substantially perpendicular to each other.

Next, an optical device including a hard-coated film of the present invention stacked therein is described using a polarizing plate as an example. The hard-coated film of the present invention and a polarizer or polarizing plate may be laminated with an adhesive or a pressure-sensitive adhesive to form a polarizing plate having the function according to the invention.

The polarizer is not especially limited. Examples of the polarizer include: a film that is uniaxially stretched after a hydrophilic polymer film, such as a polyvinyl alcohol type film, a partially formalized polyvinyl alcohol type film, an ethylene-vinyl acetate copolymer type partially saponified film, etc., allowed to adsorb dichromatic substances such as iodine and a dichromatic dye; and polyene type oriented films, such as a dehydrated polyvinyl alcohol film, a dehydrochlorinated polyvinyl chloride film, etc. Especially, a polarizer formed of a polyvinyl alcohol type film and a dichromatic material such as iodine is preferred because it has a high polarization dichroic ratio. Although the thickness of the polarizer is not especially limited, the thickness of about 5 to 80 μm is commonly adopted.

A polarizer that is uniaxially stretched after a polyvinyl alcohol type film is dyed with iodine can be produced by dipping and dyeing a polyvinyl alcohol type film in an aqueous solution of iodine and then stretching it by 3 to 7 times the original length. The aqueous solution of iodine may contain boric acid, zinc sulfate, zinc chloride, etc., if necessary. Separately, the polyvinyl alcohol type film may be dipped in an aqueous solution containing boric acid, zinc sulfate, zinc chloride, etc. Furthermore, before dyeing, the polyvinyl alcohol type film may be dipped in water and rinsed if needed. Rinsing the polyvinyl alcohol type film with water allows soils and blocking inhibitors on the polyvinyl alcohol type film surface to be washed off and also provides an effect of preventing ununiformity, such as unevenness of dyeing, that may be caused by swelling the polyvinyl alcohol type film. Stretching may be applied after dyeing with iodine or may be applied concurrently with dyeing, or conversely, dyeing with iodine may be applied after stretching. Stretching can be carried out in aqueous solutions, such as boric acid, potassium iodide, etc. or in water baths.

The transparent protective film formed on one or both surfaces of the polarizer preferably is excellent in transparency, mechanical strength, thermal stability, moisture-blocking properties, retardation value stability, or the like. Examples of the material for forming the transparent protective film include the same materials as those used for the transparent plastic film substrate.

Moreover, the polymer films described in JP-A No. 2001-343529 (WO01/37007) also can be used as the transparent protective film. The polymer films described in JP-A No. 2001-343529 are formed of, for example, resin compositions including (A) thermoplastic resins having at least one of a substituted imide group and a non-substituted imide group in the side chain thereof, and (B) thermoplastic resins having at least one of a substituted phenyl group and a non-substituted phenyl group and a nitrile group in the side chain thereof. Examples of the polymer films formed of the resin compositions described above include one formed of a resin composition including: an alternating copolymer containing isobutylene and N-methyl maleimide; and an acrylonitrile-styrene copolymer. The polymer film can be produced by extruding the resin composition in the form of film. The polymer film exhibits a small retardation and a small photoelastic coefficient and thus can eliminate defects such as unevenness due to distortion when a protective film or the like used for a polarizing plate. The polymer film also has low moisture permeability and thus has high durability against moistening.

In terms of polarizing properties, durability, and the like, cellulose resins such as triacetyl cellulose and norbornene resins are preferably used for the transparent protective film. Examples of the transparent protective film that are commercially available include FUJITAC (trade name) manufactured by Fuji Photo Film Co., Ltd., ZEONOA (trade name) manufactured by Nippon Zeon Co., Ltd., and ARTON (trade name) manufactured by JSR Corporation.

The thickness of the transparent protective film is not particularly limited. It is, for example, in the range of 1 to 500 μm in viewpoints of strength, workability such as a handling property, a thin layer property, etc. In the above range, the transparent protective film can mechanically protect a polarizer and can prevent a polarizer from shrinking and retain stable optical properties even when exposed to high temperature and high humidity. The thickness of the transparent protective film is preferably in the range of 5 to 200 μm and more preferably 10 to 150 μm.

The polarizing plate in which the hard-coated antiglare film is stacked is not particularly limited. The polarizing plate may be a laminate of the hard-coated film, the transparent protective film, the polarizer, and the transparent protective film that are stacked in this order or a laminate of the hard-coated film, the polarizer, and the transparent protective film that are stacked in this order.

Hard-coated antiglare films of the present invention and various optical devices, such as polarizing plates, including the hard-coated antiglare films can be preferably used in various image displays such as a liquid crystal display, etc. The liquid crystal display of the present invention has the same configuration as those of conventional liquid crystal displays except for including a hard-coated film of the present invention. The liquid crystal display of the present invention can be manufactured by suitably assembling several parts such as a liquid crystal cell, optical components such as a polarizing plate, and, if necessity, a lighting system (for example, a backlight), and incorporating a driving circuit, for example. The liquid crystal cell is not particularly limited. The liquid crystal cell can be of any type such as TN type, STN type, π type, etc.

In the present invention, the configurations of liquid crystal displays are not particularly limited. The liquid crystal displays of the present invention include, for example, one in which the optical device is disposed on one side or both sides of a liquid crystal cell, one in which a backlight or a reflector is used for a lighting system, etc. In these liquid crystal displays, the optical device of the present invention can be disposed on one side or both sides of the liquid crystal cell. When disposing the optical devices in both the sides of the liquid crystal cell, they may be identical to or different from each other. Furthermore, various optical components and optical parts such as a diffusion plate, an antiglare layer, an antireflection film, a protective plate, a prism array, a lens array sheet, an optical diffusion plate, backlight, etc. may be disposed in the liquid crystal displays.

### EXAMPLES

Next, examples of the present invention are described together with comparative examples. However, the present invention is not limited by the following examples and comparative examples.

### Example 1

A resin material (GRANDIC PC 1097 (trade name), manufactured by DAINIPPON INK AND CHEMICALS, INCORPORATED, with a solid concentration of 66% by weight) was prepared. The resin material contained Component A, Component B, Component C, a photopolymerization initiator, and a mixed solvent described below. Then 70 parts by weight of PMMA particles (MBX-8SSTN (trade name), manufactured by SEKISUI PLASTICS CO., LTD.) whose weight average particle size was 8 μm, and 0.1 part by weight of a leveling agent (GRANDIC PC-F479 (trade name), manufactured by DAINIPPON INK AND CHEMICALS, INCORPORATED) were added and mixed to 100 parts by weight of solid content of the resin material described above. This mixture was diluted with a solvent (ethyl acetate) in such a manner that a solid concentration of 55% by weight was obtained. Thus a material for forming a hard-coating antiglare layer was prepared. The material for forming a hard-coating antiglare layer was applied onto a transparent plastic film substrate (a triacetyl cellulose film with a thickness of 80 μm and a refractive index of 1.48) with a #24 bar coater. Thus a coating film was formed. After the application, it was heated at 100° C. for one minute and thus the coating film was dried. Thereafter, it was irradiated with ultraviolet light at an accumulated light intensity of 300 mJ/cm² using a high pressure mercury lamp and thereby the coating film was cured to form a 25-μm thick hard-coating antiglare layer. Thus an intended hard-coated antiglare film was obtained. Most of the PMMA fine particles had an aspect ratio of less than 1.05.

### Component A: isophorone diisocyanate type urethane acrylate (100 parts by weight)

### Component B: dipentaerythritol hexaacrylate (38 parts by weight), pentaerythritol tetraacrylate (40 parts by weight), and pentaerythritol triacrylate (15.5 parts by weight)

### Component C: a polymer or copolymer having a repeating unit represented by General Formula (1) described above, or a mixture of the polymer and copolymer (30 parts by weight)

Photopolymerization initiator: 1.8 parts by weight of IRGACURE 184 (trade name, manufactured by Ciba Specialty Chemicals), and 5.6 parts by weight of Lucirin type photopolymerization initiator
Mixed solvent: butyl acetate:ethyl acetate (weight ratio)=3:4

### Example 2

A resin material (GRANDIC PC1071 (trade name), manufactured by DAINIPPON INK AND CHEMICALS, INCORPORATED, with a solid concentration of 66% by weight) was prepared. The resin material contained Component A, Component B, Component C, a photopolymerization initiator, and a mixed solvent described below. Then 50 parts by weight of PMMA particles (MX1000 (trade name), manufactured by Soken Chemical & Engineering Co., Ltd.) whose weight average particle size was 10 μm, and 0.5 part by weight of a leveling agent (GRANDIC PC4-4133, manufactured by DAINIPPON INK AND CHEMICALS, INCORPORATED) were added and mixed to 100 parts by weight of solid content of the resin material described above. This mixture was diluted with a solvent (n-butanol) in such a manner that a solid concentration of 35% by weight was obtained. Thus a material for forming a hard-coating antiglare layer was prepared. Then a hard-coated antiglare film was produced by the same operation under the same conditions as in Example 1 except that the aforementioned material for forming a hard-coating antiglare layer was used and a #40 bar coater was employed. The hard-coating antiglare layer of the hard-coated antiglare film of this example had a thickness of 24 μm. Most of the PMMA fine particles had an aspect ratio of less than 1.05.

### Component A: urethane acrylate produced with pentaerythritol acrylate and hydrogenated xylene diisocyanate (100 parts by weight)

### Component B: dipentaerythritol hexaacrylate (49 parts by weight), pentaerythritol tetraacrylate (41 parts by weight), and pentaerythritol triacrylate (24 parts by weight)

### Component C: a polymer or copolymer having a repeating unit represented by General Formula (1) described above, or a mixture of the polymer and copolymer (59 parts by weight)

Photopolymerization initiator: 3 parts by weight of IRGACURE 184 (trade name, manufactured by Ciba Specialty Chemicals)
Mixed solvent: butyl acetate:ethyl acetate (weight ratio)=89:11

### Example 3

The same resin material as that employed in Example 2 was used. Then 30 parts by weight of PMMA particles (MX1000 (trade name), manufactured by Soken Chemical & Engineering Co., Ltd.) whose weight average particle size was 10 μm, and 0.5 part by weight of a leveling agent (GRANDIC PC4-4133, manufactured by DAINIPPON INK AND CHEMICALS, INCORPORATED) were added and mixed to 100 parts by weight of solid content of the resin material described above. This mixture was diluted with a solvent (cellosolve acetate) in such a manner that a solid concentration of 35% by weight was obtained. Thus a material for forming a hard-coating antiglare layer was prepared. Then a hard-coated antiglare film was produced by the same operation under the same conditions as in Example 1 except that the aforementioned material for forming a hard-coating antiglare layer was used and a #40 bar coater was employed. The hard-coating antiglare layer of the hard-coated antiglare film of this example had a thickness of 25 μm. Most of the PMMA fine particles had an aspect ratio of less than 1.05.

### Example 4

The same resin material as that employed in Example 1 was used. Then 20 parts by weight of PMMA particles (XX40AA (trade name), manufactured by SEKISUI PLASTICS CO., LTD.) whose weight average particle size was 7.2 μm, and 0.5 part by weight of a leveling agent (GRANDIC PC4-4133, manufactured by DAINIPPON INK AND CHEMICALS, INCORPORATED) were added and mixed to 100 parts by weight of solid content of the resin material described above. This mixture was diluted with a solvent (ethyl acetate) in such a manner that a solid concentration of 55% by weight was obtained. Thus a material for forming a hard-coating antiglare layer was prepared. Then a hard-coated antiglare film was produced by the same operation under the same conditions as in Example 1. The hard-coating antiglare layer of the hard-coated antiglare film of this example had a thickness of 22 μm. Most of the PMMA fine particles had an aspect ratio of less than 1.05.

### Example 5

The same resin material as that employed in Example 1 was used. Then 20 parts by weight of PMMA particles (MBX-8SSTN (trade name), manufactured by SEKISUI PLASTICS CO., LTD.) whose weight average particle size was 8 μm, 25 parts by weight of silica particles (SYLOPHOBIC 702 (trade name), manufactured by FUJI SILYSIA CHEMICAL LTD.) whose average weight particle size was 2.5 μm, and 0.1 part by weight of a leveling agent (GRANDIC PCF479, manufactured by DAINIPPON INK AND CHEMICALS, INCORPORATED) were added and mixed to 100 parts by weight of solid content of the resin material described above. This mixture was diluted with a solvent (ethyl acetate) in such a manner that a solid concentration of 55% by weight was obtained. Thus a material for forming a hard-coating antiglare layer was prepared. Then a hard-coated antiglare film was produced by the same operation under the same conditions as in Example 1. The hard-coating antiglare layer of the hard-coated antiglare film of this example had a thickness of 25 μm. Most of the PMMA fine particles had an aspect ratio of less than 1.05. Most of the silica particles had an aspect ratio of at least 1.6.

### Example 6

The same resin material as that employed in Example 2 was used. Then 30 parts by weight of PMMA particles (MX1000 (trade name), manufactured by Soken Chemical & Engineering Co., Ltd.) whose weight average particle size was 10 μm, and 0.5 part by weight of a leveling agent (GRANDIC PC4-4133, manufactured by DAINIPPON INK AND CHEMICALS, INCORPORATED) were added and mixed to 100 parts by weight of solid content of the resin material described above. This mixture was diluted with a solvent (cellosolve acetate) in such a manner that a solid concentration of 35% by weight was obtained. Thus a material for forming a hard-coating antiglare layer was prepared. Then a hard-coated antiglare film was produced by the same operation under the same conditions as in Example 1 except that the aforementioned material for forming a hard-coating antiglare layer was used and a #40 bar coater was employed. The hard-coating antiglare layer of the hard-coated antiglare film of this example had a thickness of 23 μm. Most of the PMMA fine particles had an aspect ratio of less than 1.05.

### Example 7

A hard-coated antiglare film was produced by the same operation under the same conditions as in Example 3 except that 45 parts by weight of PMMA particles (MX1000 (trade name), manufactured by Soken Chemical & Engineering Co., Ltd.) whose weight average particle size was 10 μm was used, the solvent was changed to ethyl acetate, the mixture was diluted in such a manner that a solid concentration of 55% by weight was obtained, and a #22 bar coater was used. The hard-coating antiglare layer of the hard-coated antiglare film of this example had a thickness of 18 μm. Most of the PMMA fine particles had an aspect ratio of less than 1.05.

### Comparative Example 1

The same resin material as that employed in Example 1 was used. Then 80 parts by weight of PMMA particles (MBX8SSTN (trade name), manufactured by SEKISUI PLASTICS CO., LTD.) whose weight average particle size was 8 μm, and 0.1 part by weight of a leveling agent (GRANDIC PC-F479, manufactured by DAINIPPON INK AND CHEMICALS, INCORPORATED) were added and mixed to 100 parts by weight of solid content of the resin material described above. This mixture was diluted with a solvent (ethyl acetate) in such a manner that a solid concentration of 55% by weight was obtained. Thus a material for forming a hard-coating antiglare layer was prepared. Then a hard-coated antiglare film was produced by the same operation under the same conditions as in Example 1. The hard-coating antiglare layer of the hard-coated antiglare film of this comparative example had a thickness of 25 μm.

### Comparative Example 2

The same resin material as that employed in Example 1 was used. Then 30 parts by weight of PMMA particles (MBX8SSTN (trade name), manufactured by SEKISUI PLASTICS CO., LTD.) whose weight average particle size was 8 μm, 10 parts by weight of silica particles (SYLOPHOBIC 100 (trade name), manufactured by FUJI SILYSIA CHEMICAL LTD.) whose average weight particle size was 1.4 μm, and 0.1 part by weight of a leveling agent (GRANDIC PC-F479, manufactured by DAINIPPON INK AND CHEMICALS, INCORPORATED) were added and mixed to 100 parts by weight of solid content of the resin material described above. This mixture was diluted with a solvent (ethyl acetate) in such a manner that a solid concentration of 55% by weight was obtained. Thus a material for forming a hard-coating antiglare layer was prepared. Then a hard-coated antiglare film was produced by the same operation under the same conditions as in Example 1. The hard-coating antiglare layer of the hard-coated antiglare film of this comparative example had a thickness of 25 μm. Most of the PMMA fine particles had an aspect ratio of less than 1.05. Most of the silica particles had an aspect ratio of at least 1.6.

### Comparative Example 3

The same resin material as that employed in Example 1 was used. Then 30 parts by weight of PMMA particles (MBX8SSTN (trade name), manufactured by SEKISUI PLASTICS CO., LTD.) whose weight average particle size was 8 μm, 15 parts by weight of silica particles (SYLOPHOBIC 702 (trade name), manufactured by FUJI SILYSIA CHEMICAL LTD.) whose average particle size was 2.5 μm, 6 parts by weight of silica particles (TOSPEAR (trade name), manufactured by TOSHIBA SILICONES CO., LTD.) whose weight average particle size was 4.5 μm, and 0.1 part by weight of a leveling agent (GRANDIC PC-F479, manufactured by DAINIPPON INK AND CHEMICALS, INCORPORATED) were added and mixed to 100 parts by weight of solid content of the resin material described above. This mixture was diluted with a solvent (ethyl acetate) in such a manner that a solid concentration of 55% by weight was obtained. Thus a material for forming a hard-coating antiglare layer was prepared. Then a hard-coated antiglare film was produced by the same operation under the same conditions as in Example 1. The hard-coating antiglare layer of the hard-coated antiglare film of this comparative example had a thickness of 25 μm. Most of the PMMA fine particles and the silica particles whose weight average particle size was 4.5 μm had an aspect ratio of less than 1.05. Most of the silica particles whose weight average particle size was 1.4 μm had an aspect ratio of at least 1.6.

### Comparative Example 4

The same resin material as that employed in Example 1 was used. Then 30 parts by weight of PMMA particles (XX40AA (trade name), manufactured by SEKISUI PLASTICS CO., LTD.) whose weight average particle size was 7.2 μm, and 0.5 part by weight of a leveling agent (GRANDIC PC4-4133, manufactured by DAINIPPON INK AND CHEMICALS, INCORPORATED) were added and mixed to 100 parts by weight of solid content of the resin material described above. This mixture was diluted with a solvent (ethyl acetate) in such a manner that a solid concentration of 55% by weight was obtained. Thus a material for forming a hard-coating antiglare layer was prepared. Then a hard-coated antiglare film was produced by the same operation under the same conditions as in Example 1. The hard-coating antiglare layer of the hard-coated antiglare film of this comparative example had a thickness of 22 μm.

### Comparative Example 5

The hard-coating resin used herein was an ultraviolet-curable resin containing 40% by weight of urethane acrylate, 40% by weight of polyester acrylate, and 20% by weight of butyl acetate in terms of mixing ratio. Then 6.5 parts by weight of silicon oxide particles (SYLOPHOBIC 100 (trade name), manufactured by FUJI SILYSIA CHEMICAL LTD.) whose weight average particle size was 1.3 μm, 7.5 parts by weight of silicon oxide particles (SYLOPHOBIC 702, manufactured by FUJI SILYSIA CHEMICAL LTD.) whose weight average particle size was 2.5 μm, 0.5 part by weight of a leveling agent (DEFENSA MCF323, manufactured by DAINIPPON INK AND CHEMICALS, INCORPORATED), and 5 parts by weight of a photopolymerization initiator (IRGACURE 184 (trade name), manufactured by Ciba Specialty Chemicals) were added and mixed to 100 parts by weight of the hard-coating resin described above. This mixture was diluted with a solvent (toluene) in such a manner that a solid concentration of 45% by weight was obtained. Thus a material for forming a hard-coating antiglare layer was prepared. Then a hard-coated antiglare film was produced by the same operation under the same conditions as in Example 1 except that the aforementioned material for forming a hard-coating antiglare layer was used. The hard-coating antiglare layer of the hard-coated antiglare film of this comparative example had a thickness of 3 μm. Most of the respective fine particles had an aspect ratio of at least 1.6.

### Comparative Example 6

A hard-coated antiglare film was produced by the same operation under the same conditions as in Comparative Example 5 except that 6.5 parts by weight of silicon oxide particles (SYLOPHOBIC 200 (trade name), manufactured by FUJI SILYSIA CHEMICAL LTD.) whose weight average particle size was 1.8 μm and 6.5 parts by weight of silicon oxide particles (SYLOPHOBIC 702 (trade name), manufactured by FUJI SILYSIA CHEMICAL LTD.) whose weight average particle size was 2.5 μm were used and the thickness of the hard-coating antiglare layer was 8 μm. Most of the respective fine particles had an aspect ratio of at least 1.6.

### Comparative Example 7

A hard-coated antiglare film was produced by the same operation under the same conditions as in Comparative Example 5 except that 14 parts by weight of polystyrene particles (SX350H (trade name), manufactured by Soken Chemical & Engineering Co., Ltd.) whose weight average particle size was 3.5 μm was alternatively used as the fine particles and that the thickness of the hard-coating antiglare layer was 5 μm.

### Evaluation

In the respective examples and comparative examples, various characteristics were evaluated or measured by the following methods.

### Thickness of Hard-Coating Antiglare Layer

A thickness gauge (microgauge type manufactured by Mitutoyo Corporation) was used to measure the total thickness of the hard-coated antiglare film. The thickness of the transparent plastic film substrate was subtracted from the total thickness. Thus the thickness of the hard-coating antiglare layer was calculated. The results are shown in Table 1 below.

### Haze

A haze meter HR300 (trade name, manufactured by Murakami Color Research Laboratory) was used to measure haze according to JIS K 7136 (1981 version) (haze (cloudiness)). The results are shown in Table 1 below.

### Glossiness

Glossiness was measured according to JIS K 7105 (1981 version) at a measurement angle of 60° with Digital Variable Gloss Meter UGV-5DP manufactured by Suga Test Instrument Co., Ltd. The results are shown in Table 1 below.

### Pencil Hardness

A hard-coated antiglare film was placed on a glass plate, with the surface on which the hard-coating antiglare layer was not formed facing downward. Then the surface of the hard-coating antiglare layer was subjected to a pencil hardness test according to JIS K-5400 (with a load of 500 g). Thus, the pencil hardness thereof was measured. The results are shown in Table 1 below.

### Arithmetic Average Surface Roughness Ra and Average Tilt Angle θa

A glass plate (thickness: 1.3 mm) manufactured by Matsunami Glass Ind., Ltd. was bonded to the hard-coated antiglare film surface with no hard-coating antiglare layer formed thereon, using a pressure-sensitive adhesive. Then the shape of the hard-coating antiglare layer surface was measured using a high-precision micro figure measuring instrument (SURFCORDER ET4000 (trade name), manufactured by Kosaka Laboratory Ltd.). Thereafter, the arithmetic average surface roughness Ra and average tilt angle θa were determined. The results are shown in Table 1 below. The high precision micro figure measuring instrument automatically calculates the arithmetic average surface roughness Ra and average tilt angle θa.

### Reflectance

A black acrylic plate (2.0 mm in thickness, manufactured by Mitsubishi Rayon Co., Ltd.) was bonded to the hard-coated antiglare film surface on which no hard-coating antiglare layer was formed, with an approximately 20-μm thick adhesive layer formed thereon. This eliminated reflection at the back surface of the hard-coated antiglare film. This hard-coated antiglare film was measured for reflectance of the surface of the hard-coating antiglare layer. The spectral reflectance (specular reflectance+diffuse reflectance) was measured using a spectrophotometer UV2400PC (trade mark, with an 8′-inclined integrating sphere, manufactured by Shimadzu Corporation). The reflectance was calculated according to the formula: C illuminant/total reflection index of 20 visual field (Y value). The results are shown in Table 1 below.

### Refractive Index of Hard-Coating Antiglare Layer

The refractive index of a hard-coating antiglare layer was measured using a multiwavelength Abbe refractometer (manufactured by Atago Co., Ltd., trade name: DR-M2/1550). The results are shown in Table 1 below.

### Refractive Index of Fine Particles

Fine particles were placed on a slide glass, and a refractive index standard solution was dropped on the fine particles. Thereafter, a cover glass was placed thereon. Thus a sample was prepared. The sample was observed with a microscope and thereby the refractive index of the refractive index standard solution that was obtained at the point where the profiles of the fine particles were most difficult to view at the interface with the refractive index standard solution was used as the refractive index of the fine particles. The results are shown in Table 1 below.

### White Blur Occurring when Test Piece is Viewed from 60° Oblique Direction

A black acrylic plate (with a thickness of 1.0 mm) manufactured by Nitto Jushi Kogyo Kabushiki Kaisha was bonded to the surface where no hard-coating antiglare layer had been formed in each hard-coated antiglare film, using an adhesive. Thus a test piece with no reflection at the back surface thereof was produced. With respect to this test piece, in an office environment where displays are generally used, as shown in FIG. 4, the white blur phenomenon was observed visually by looking at the test piece from the direction that forms an angle of 60° with the reference (0°) that is the direction perpendicular to the plane of the test piece. Then evaluation was made according to the following criteria. The results are indicated in Table 1 below. In FIG. 4, numeral 7 indicates a hard-coated antiglare film while numeral 8 denotes a black acrylic plate.

### Criteria:

### A: White blur is hardly observed.

### B: White blur is observed but has a little effect on visibility.

### C: White blur is observed and the deterioration in visibility can be recognized.

### D: Strong white blur is observed and deteriorates the visibility considerably.

### Reflection Occurring when Test Piece is Viewed from 60° Oblique Direction

(1) A black acrylic plate (with a thickness of 1.0 mm, manufactured by Nitto Jushi Kogyo Kabushiki Kaisha) was bonded to the surface where no hard-coating antiglare layer had been formed in the hard-coated antiglare film, using an adhesive. Thus a test piece with no reflection at the back surface thereof was produced.

(2) With the direction perpendicular to the surface of this test piece being taken as 0°, an image reflected by the surface-treated layer (a hard-coating antiglare layer) of an object located in the 60° direction was checked visually from the −60° direction. Then evaluation was made according to the following criteria. The results are indicated in Table 1 below.

### A: The object cannot be recognized.

### B: The profile of the object can be seen but is blurred.

### C: The object can be seen but is blurred slightly.

### D: The object can be seen clearly.

### Weight Average Particle Size of Fine Particles

As described earlier, by the Coulter counting method, a particle size distribution measurement apparatus (trade name: Coulter Multisizer, manufactured by Beckman Coulter, Inc.) using a pore electrical resistance method was employed to measure electrical resistance of an electrolyte corresponding to the volumes of the fine particles when the fine particles passed through the pores. Thus the number and volume of the fine particles were measured and then the weight average particle size of the fine particles was calculated. The results are indicated in Table 1 below.

TABLE 1

| | Thickness | | Refractive | | | | | | | | | | | |
|---|---|---|---|---|---|---|---|---|---|---|---|---|---|---|
| | of Hard- | Blending | Index of | | | | | | | | | | White | |
| | Coating | Amount of | Hard- | Parti- | Refractive | Relative | | | | | | Re- | blur | Reflection |
| | Antiglare | Fine | Coating | cle | Index of | Particle | | | Pencil | | | flect- | from 60° | from 60° |
| | Layer | Particles | Antiglare | Size | Fine | Size | | Glossi- | Hard- | Ra | θa | ance | oblique | oblique |
| | (μm) | (wt %) | layer | (μm) | Particles | (%) | Haze | ness | ness | (μm) | (°) | (%) | direction | direction |
| Example 1 | 25 | 70 | 1.52 | 8 | 1.49 | 32 | 63.6 | 36.1 | 4H | 0.2 | 1.56 | 4 | B | A |
| Example 2 | 24 | 50 | 1.52 | 10 | 1.49 | 42 | 62.5 | 59 | 4H | 0.161 | 1.11 | 4 | B | C |
| Example 3 | 25 | 30 | 1.52 | 10 | 1.49 | 40 | 54.8 | 60.8 | 4H | 0.23 | 1.11 | 4 | B | C |
| Example 4 | 22 | 20 | 1.52 | 7.2 | 1.55 | 33 | 45.6 | 61 | 4H | 0.25 | 1.21 | 4 | B | B |
| Example 5 | 25 | 20 | 1.52 | 8 | 1.49 | 32 | 42 | 55.9 | 4H | 0.3 | 2 | 4 | C | A |
| | | 25 | | 2.5 | 1.46 | 10 | | | | | | | | |
| Example 6 | 23 | 30 | 1.52 | 10 | 1.43 | 43 | 53 | 55.4 | 4H | 0.275 | 1.24 | 4 | C | A |
| Example 7 | 18 | 45 | 1.52 | 10 | 1.49 | 56 | 52.9 | 66.0 | 4H | 0.126 | 1.19 | 4 | A | C |
| Comparative | 25 | 80 | 1.52 | 8 | 1.49 | 32 | 64 | 3.6 | 4H | 0.256 | 2.11 | 4 | D | A |
| Example 1 | | | | | | | | | | | | | | |
| Comparative | 25 | 30 | 1.52 | 8 | 1.49 | 32 | 46.6 | 51.8 | 4H | 0.127 | 0.94 | 4 | A | D |
| Example 2 | | 10 | | 1.4 | 1.46 | 6 | | | | | | | | |
| Comparative | 25 | 30 | 1.52 | 8 | 1.49 | 32 | 71.4 | 49.6 | 4H | 0.116 | 1.01 | 4 | A | D |
| Example 3 | | 15 | | 2.5 | 1.46 | 10 | | | | | | | | |
| | | 6 | | 4.5 | 1.46 | 18 | | | | | | | | |
| Comparative | 22 | 30 | 1.52 | 7.2 | 1.55 | 33 | 59.6 | 45 | 4H | 0.36 | 2.14 | 4 | D | A |
| Example 4 | | | | | | | | | | | | | | |
| Comparative | 3 | 6.5 | 1.53 | 1.3 | 1.46 | 43 | 6.4 | 76.1 | 3H | 0.28 | 1.65 | 4 | C | A |
| Example 5 | | 7.5 | | 2.5 | | 83 | | | | | | | | |
| Comparative | 8 | 6.5 | 1.53 | 1.8 | 1.46 | 23 | | | | | | | | |
| Example 6 | | 6.5 | | 2.5 | | 31 | 11.7 | 51.2 | 3H | 0.21 | 2.2 | 4 | D | A |
| Comparative | 5 | 14 | 1.53 | 3.5 | 1.59 | 70 | 43.9 | 51.8 | 3H | 0.18 | 1.8 | 4 | C | B |
| Example 7 | | | | | | | | | | | | | | |

As indicated in Table 1, the hard-coated antiglare films of all the examples had a sufficiently high hardness, allowed white blur in the oblique directions to be effectively prevented from occurring, and also had excellent antiglare properties (against reflection when viewed from a 60° oblique direction). On the other hand, in the hard-coated antiglare films of all the comparative examples, part or all of the respective conditions including the thickness of the hard-coating antiglare layer, weight average particle size, arithmetic average surface roughness Ra, and average tilt angle θa departed from the ranges of the present invention. Accordingly, they were poor in one or more of the properties of the hardness, white blur in the oblique directions, and antiglare properties. None of them satisfied all the properties.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A hard-coated antiglare film, comprising:
a transparent plastic film substrate; and
a hard-coating antiglare layer that is formed of fine particles and a hard-coating resin on at least one surface of the transparent plastic film substrate, wherein
the hard-coating layer has a thickness in the range of 15 to 30 μm,
the fine particles have a weight average particle size in the range of 30 to 75% of a thickness of the hard-coating antiglare layer,
the hard-coating antiglare layer surface has an unevenness formed by the fine particles, said unevenness of the surface is such that an average tilt angle θa is in the range of 1.0° to 2.0°, and an arithmetic average surface roughness Ra according to JIS B 0601 (1994 version) is in the range of 0.12 to 0.30 μm.

2. The hard-coated antiglare film according to claim 1, wherein the fine particles are of a plurality of types that include at least two types of fine particles whose weight average particle sizes are different from each other, and at least one of the plurality of types of the fine particles has a weight average particle size in a range of 30 to 75% of the thickness of the hard-coating antiglare layer.

3. The hard-coated antiglare film according to claim 1, wherein the fine particles each have a spherical shape.

4. The hard-coated antiglare film according to claim 1, wherein the hard-coated antiglare film has a glossiness according to JIS K 7105 (1981 version) of at most 60.

5. The hard-coated antiglare film according to claim 1, wherein the hard-coating resin contains Component A, Component B, and Component C,
wherein Component A is at least one of urethane acrylate and urethane methacrylate,
Component B is at least one of polyol acrylate and polyol methacrylate, and
Component C is a polymer or copolymer that is formed of at least one of Components C1 and C2, or a mixed polymer of the polymer and the copolymer,
wherein Component C1 is alkyl acrylate having an alkyl group containing at least one of a hydroxyl group and an acryloyl group, and
Component C2 is alkyl methacrylate having an alkyl group containing at least one of a hydroxyl group and an acryloyl group.

6. The hard-coated antiglare film according to claim 1, further comprising an antireflection layer formed on the hard-coating antiglare layer.

7. The hard-coated antiglare film according to claim 6, wherein the antireflection layer contains hollow spherical silicon oxide ultrafine particles.

8. A polarizing plate, comprising a polarizer and the hard-coated antiglare film according to claim 1.

9. An image display, comprising the hard-coated antiglare film according to claim 1.

10. An image display, comprising the polarizing plate according to claim 8.

11. A method of manufacturing a hard-coated antiglare film comprising a transparent plastic film substrate and a hard-coating antiglare layer formed on at least one surface of the transparent plastic film substrate, comprising:
preparing a material for forming the hard-coating antiglare layer containing fine particles, a hard-coating resin, and a solvent;
forming a coating film by applying the material for forming the hard-coating antiglare layer onto at least one surface of the transparent plastic film substrate, and
forming the hard-coating layer by curing the coating film,
wherein the hard-coating layer has a thickness of 15 to 30 μm,
the fine particles have a weight average particle size of 30 to 75% of a thickness of the hard-coating layer,
the solvent contains ethyl acetate at a ratio of at least 50% by weight of the total amount,
the hard-coating antiglare layer surface has an unevenness formed by the fine particles, said unevenness of the surface is such that an average tilt angle θa is in the range of 1.0° to 2.0°, and an arithmetic average surface roughness Ra according to JIS B 0601 (1994 version) is in the range of 0.12 to 0.30 μm.

12. The method of manufacturing a hard-coated antiglare film according to claim 11, wherein the fine particles are of a plurality of types that include at least two types of fine particles whose weight average particle sizes are different from each other, and at least one of the plurality of types of the fine particles has a weight average particle size in a range of 30 to 75% of the thickness of the hard-coating antiglare layer.

13. The method of manufacturing a hard-coated antiglare film according to claim 11, wherein the fine particles each have a spherical shape.

14. The method of manufacturing a hard-coated antiglare film according to claim 11, wherein the hard-coating antiglare layer is formed in such a manner that the resulting hard-coated antiglare film has a glossiness according to JIS K 7105 (1981 version) of at most 60.

15. The method of manufacturing a hard-coated antiglare film according to claim 11, wherein the hard-coating resin contains Component A, Component B, and Component C,
wherein Component A is at least one of urethane acrylate and urethane methacrylate,
Component B is at least one of polyol acrylate and polyol methacrylate, and
Component C is a polymer or copolymer that is formed of at least one of Components C1 and C2, or a mixed polymer of the polymer and the copolymer,
wherein Component C1 is alkyl acrylate having an alkyl group containing at least one of a hydroxyl group and an acryloyl group, and Component C2 is alkyl methacrylate having an alkyl group containing at least one of a hydroxyl group and an acryloyl group.
